(19) United States
(12) Patent Application Publication
(10) Pub. No.: US 2026/0316819 A1
(43) Pub. Date: Oct. 15, 2026

(54) Steering Wheel

(71) Applicant: MERCEDES-BENZ GROUP AG, Stuttgart (DE)

(72) Inventor: Giovanni LA PLACA, Ludwigsburg (DE)

(21) Appl. No.: 19/105,514

(22) PCT Filed: Jul. 5, 2023
(86) PCT No.: PCT/EP2023/068611

§ 371 Date: Feb. 21, 2025

(30) Foreign Application Priority Data
Aug. 30, 2022 (DE) 10 2022 003 162.0

(51) Int. Cl. B62D 1/11

(52) U.S. Cl. CPC B62D 1/11

(57) ABSTRACT

A steering wheel includes a steering handle that is formed by a first handle disposed on a first side of the steering wheel and a second handle disposed on a second side of the steering wheel. An impact absorber is disposed in a center of the steering wheel between the first side and the second side. The first handle is connected to the impact absorber via at least a first three telescopic adjustment elements and the second handle is connected to the impact absorber via at least a second three telescopic adjustment elements.

### BACKGROUND AND SUMMARY OF THE INVENTION

The invention relates to a steering wheel.

Steering wheels are known to be used to specify or to select the steering movement of a vehicle.

In such steering wheels, a steering handle formed as a steering wheel rim is usually connected to an impact absorber arranged in the center of the steering wheel by means of steering wheel spokes.

From the generic publication DE 10 2016 115 466 A1, on which the present invention is based, a control horn for the steering a motor vehicle is known on this subject, which has two steering handles projecting laterally in opposite directions. By means of a motor-driven adjusting device, the steering handles can be shifted between a use position with a greater distance between the steering handles and a standby position with a smaller distance between the steering handles. In addition, the two steering handles can be rotated towards the driver of the motor vehicle in the use position and turned away from the driver in the standby position.

DE 10 2021 005 210 A1 discloses a steering arrangement for a vehicle, comprising a rotatable steering wheel, which is connected to means for shifting the steering wheel. In a steering arrangement which enables optimum steering ergonomics for the driver, the rotatable steering wheel is fixed in an articulated manner to a vehicle component arranged on the bow side behind the steering wheel via several means for shifting the steering wheel in the form of longitudinally adjustable struts.

An actuating device for manually actuating a vehicle function with a handle element is known from DE 10 2016 002 204 A, wherein the handle element is connected to an axis of rotation via a rod-shaped element, and the vehicle function is executed depending on the angle of rotation of the axis of rotation generated by a pivoting movement of the handle element. According to the invention, it is provided that the rod-shaped element can be continuously or gradually lengthened and/or shortened by means of a length adjustment device in order to adjust the distance between the handle element and the axis of rotation.

Based on this known prior art, the object of the invention is to specify a generic steering wheel in which the steering wheel and, in particular, the steering handle of the steering wheel can be positioned as desired in a simple manner.

In the steering wheel according to the invention with two handles as a steering handle, (at least) three telescopic adjustment elements are provided for connecting a respective handle to the impact absorber of the steering wheel in order to be able to position or adjust the respective handle in a defined manner in all spatial directions. This means that the two handles provided as steering handles can be adjusted as required either together or independently of each other in all three spatial dimensions by radial displacement, vertical displacement, rotational movement, tilting movement or by a combination of these types of movement or, if necessary, also by other types of movement.

In order to ensure simple and complete adjustability of a handle, the at least three telescopic adjustment elements are arranged on one side of the steering wheel in at least two planes offset from one another. If three telescopic adjustment elements on one side of the steering wheel are connected to a respective handle, the upper telescopic adjustment element and the lower telescopic adjustment element can be arranged in the same plane, while the center telescopic adjustment element can be arranged in a plane offset to this.

If more than three telescopic adjustment elements are arranged on one side of the steering wheel, this could possibly have a positive effect on the stability of the entire arrangement of the steering wheel.

The telescopic adjustment elements are each connected via a 3D bearing, for example via a ball bearing or a flexible rubber element, both to a handle and to the impact absorber of the steering wheel. This means that the 3D bearing is arranged at both ends of a telescopic adjustment element and thus enables easy movement of the handle in all dimensions.

For length adjustment of a telescopic adjustment element, i.e., to retract and extend a telescopic adjustment element from a housing, an electromotive drive device can be integrated in the respective telescopic adjustment element, with which an electromotive retraction and extension of a telescopic adjustment element can be implemented.

Alternatively, for length adjustment of a telescopic adjustment element, i.e., to retract and extend a telescopic adjustment element from a housing, a pneumatic drive device or a hydraulic drive device can also be integrated in the respective telescopic adjustment element, with which a pneumatic retraction and extension of a telescopic adjustment element or a hydraulic retraction and extension of a telescopic adjustment element can be implemented.

In an advantageous development of the invention, a worm drive integrated in the respective adjusting element is provided for length adjustment of the telescopic adjusting elements, by means of which a precise and reliable length adjustment of the telescopic adjusting elements can be implemented.

To ensure that the telescopic adjustment elements provided between a respective handle and the impact absorber of the steering wheel are not visible and thus do not disturb the aesthetic impression in the interior of the motor vehicle, these telescopic adjustment elements can be covered, in particular over their entire possible adjustment path.

This cover for the telescopic adjustment elements can preferably be formed as a flexible bellows or as an interlocking staggered cover element or as a cover element that can be inherently shifted.

The steering signal, i.e., the actual rotary movement of the steering handle of the steering wheel or the handles of the steering wheel by the driver of the motor vehicle, is here transmitted to the steering column by the telescopic adjustment elements.

Preferably, in doing so, a (dynamic) adjustment of the steering handle of the steering wheel, i.e., the two handles of the steering wheel, during a steering operation of the steering wheel can be undertaken. For example, the respective upper handle can be adjusted slightly forwards (seen in the longitudinal direction of the vehicle), and in doing so impart a dynamic and sporty steering feel.

Overall, the design of the steering wheel according to the invention makes it possible to implement a large number of different adjustment options or setting options of the two handles of the steering wheel.

For example, in order to enable improved entry into the motor vehicle or improved exit from the motor vehicle for an occupant of the motor vehicle and in particular for the driver of the motor vehicle, the two handles can be adjusted axially and/or in the vertical direction for this purpose. This adjustment of the handles can, for example, also be coupled to a memory unit for the seat adjustment of the motor vehicle (a so-called “seat memory”), such that the respective position of the two handles is automatically approached in the corresponding conditions or in certain operating states of the motor vehicle.

For example, in order to provide the steering wheel with a character that is individualized and appropriate for the respective driver, the distance between the two handles and thus the “radius” of the steering wheel can also be adjusted, for example by means of a predetermined and stored driver profile. Thus, for example, a sportier steering wheel with a small distance between the two handles can be easily implemented.

Along with a radial adjustment of the two handles, i.e., the distance between the two handles, or a height adjustment of the two handles, i.e., the adjustment of the two handles in the vertical direction as an entry aid, a tilting movement of the two handles can also be implemented in particular, whereby, for example, an advantageous, comfortable and/or ergonomically favourable position of the steering wheel can be set for the driver of the motor vehicle for (partially) autonomously driven sections of the motor vehicle.

Advantageously, however, any other positioning or adjustment of the two handles of the steering wheel can also be specified or adjusted, in particular a combination of the adjustment variants of the two handles presented here.

In this way, an adequate and advantageous positioning of the two handles and thus of the steering wheel as a whole can be implemented for the respective driving situation of the motor vehicle and/or for the respective driver of the motor vehicle individually.

Further advantages, features and details of the invention emerge from the description below of a preferred exemplary embodiment and by means of the drawings.

### BRIEF DESCRIPTION OF THE DRAWINGS

FIG. 1 is a schematic depiction of a telescopic adjustment element of the steering wheel;

FIG. 2 is a schematic depiction of the front view of a steering wheel with telescopic adjustment elements;

FIG. 3 is a schematic depiction of the top view of a steering wheel with telescopic adjustment elements;

FIG. 4 is a schematic depiction of the side view of a steering wheel with telescopic adjustment elements;

FIG. 5 is a depiction of a first adjustment option of the two handles of the steering wheel;

FIG. 6 is a depiction of a second adjustment option of the two handles of the steering wheel;

FIG. 7 is a depiction of a third adjustment option of the two handles of the steering wheel; and

FIG. 8 is a depiction of a fourth adjustment option of the two handles of the steering wheel.

### DETAILED DESCRIPTION OF THE DRAWINGS

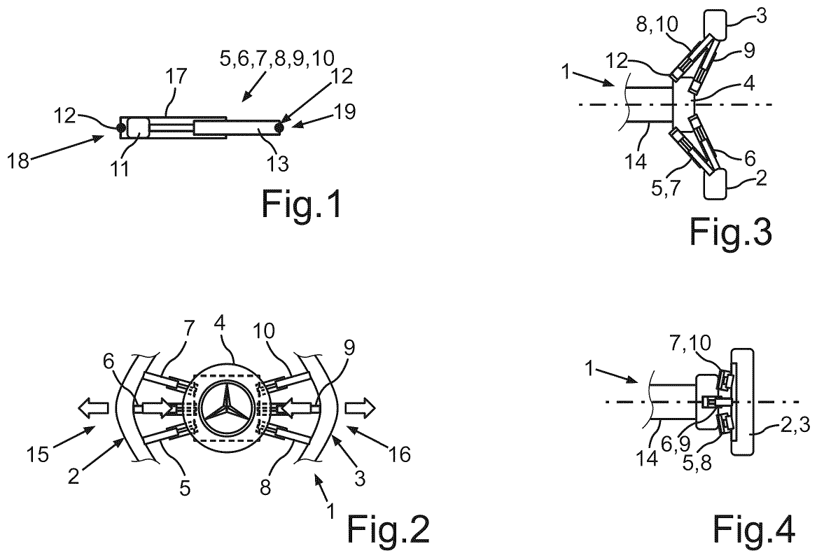

FIG. 1 shows a principle depiction of one of the telescopic adjustment elements 5, 6, 7; 8, 9, 10 provided in the steering wheel 1 according to the invention.

Each of these telescopic adjusting elements 5, 6, 7; 8, 9, 10 has a drive device 11, for example in the form of an electric motor with worm drive, by means of which the boom 13 can be moved out of the housing 17 of the telescopic adjusting element 5, 6, 7; 8, 9, 10 and can be moved into the housing 17 of the telescopic adjusting element 5, 6, 7; 8, 9, 10.

At the two ends 18, 19 of a telescopic adjusting element 5, 6, 7; 8, 9, 10, a 3D bearing 12 is arranged, for example in the form of a ball bearing, by means of which a simple adjustment of the arcuate handles 2; 3 connected to a telescopic adjusting element 5, 6, 7; 8, 9, 10 can be implemented in all desired dimensions as a handle of the steering wheel 1.

According to the front view in FIG. 2, the steering wheel 1 has a curved handle 2; 3 on each of the two sides 15; 16 as the handle of the steering wheel 1.

Each of these two handles 2; 3 is connected to the impact absorber 4 of the steering wheel 1 via, for example, three telescopic adjustment elements 5, 6, 7; 8, 9, 10. This means that on the one side 15 of the steering wheel 1, the handle 2 is connected to the impact absorber 4 of the steering wheel 1 via the three telescopic adjustment elements 5, 6, 7, and on the other side 16 of the steering wheel 1, the handle 3 is connected to the impact absorber 4 of the steering wheel 1 via the three telescopic adjustment elements 8, 9, 10.

The two outer telescopic adjustment elements 5, 7 on the one side 15 of the steering wheel 1 or the two outer telescopic adjustment elements 8, 10 on the other side 16 of the steering wheel 1 are arranged in the same plane, while the center telescopic adjustment element 6 on the one side 15 of the steering wheel 1 or the center telescopic adjustment element 9 on the other side 16 of the steering wheel 1 are each arranged in a plane that is offset in relation to it.

The telescopic adjustment elements 5, 6, 7; 8, 9, 10 are each connected at the one end 18 to the corresponding handle 2; 3 and at the other end 19 to the impact absorber 4 of the steering wheel 1 via the 3D bearings 12, which are in the form of ball bearings, for example.

In the top view of the steering wheel 1 according to FIG. 3 and in the side view of the steering wheel 1 according to FIG. 4, it can be seen that the three telescopic adjustment elements 5, 6, 7; 8, 9, 10 are each arranged on one side 15; 16 of the steering wheel 1 in two mutually offset planes.

In particular, it can be seen from FIG. 3 and FIG. 4 that the two telescopic adjustment elements 5, 7 or 8, 10 are arranged in one plane, while the telescopic adjustment element 6 or the telescopic adjustment element 9 are arranged in a plane that is offset in relation to it.

The impact absorber 4 of the steering wheel 1 is connected to the rotatable steering column 14, via which the rotational movement of the steering wheel 1 or the two handles 2; 3 of the steering wheel 1 is transmitted to the steering of the motor vehicle as a steering handle.

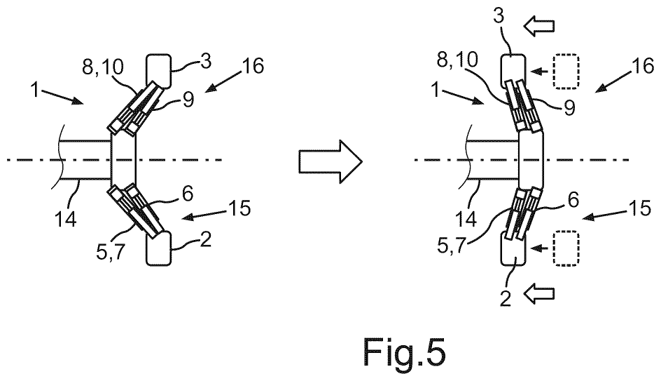

In FIG. 5, an adjustment possibility of the two handles 2; 3 of the steering wheel 1 for implementing a comfortable entry of a driver into the motor vehicle is depicted in a top view of the steering wheel 1.

For this purpose, all telescopic adjustment elements 5, 6, 7; 8, 9, 10 are folded from the starting position depicted on the left or from the starting position (left-hand depiction in FIG. 5) in the direction of the steering column 14 of the steering wheel 1 and, in doing so, the two handles 2; 3 of the steering wheel 1 are also pivoted in this direction to the end position shown on the right (right-hand depiction in FIG. 5). In doing so, a larger free space in front of the steering wheel 1 is created for the driver of the motor vehicle, which can be used by the driver of the motor vehicle, preferably when getting into the motor vehicle.

This adjustment of the telescopic adjustment elements 5, 6, 7; 8, 9, 10 and thus also of the two handles 2; 3 of the steering wheel 1 can, for example, be carried out automatically upon operation of the driver's door of the motor vehicle and/or operation of an electronic key required for access authorization to the motor vehicle, for example also by means of a personalized allocation to an electronic key. This means that the desired position of the two handles 2; 3 of the steering wheel 1 is then automatically approached or adjusted when the motor vehicle is opened. The described adjustment of the telescopic adjustment elements 5, 6, 7; 8, 9, 10 and thus also of the two handles 2; 3 of the steering wheel 1 can also be carried out in the same way when the driver of the motor vehicle gets out of the vehicle.

For example, the adjustment of the telescopic adjustment elements 5, 6, 7; 8, 9, 10 and thus also of the two handles 2; 3 of the steering wheel 1 can be coupled to an adjustment of the driver's seat when entering or leaving the motor vehicle as part of an automated and possibly personalized adjustment of the seats (and thus to a so-called seat memory).

In addition to adjusting the telescopic adjustment elements 5, 6, 7; 8, 9, 10 in the direction of the steering column 14, these telescopic adjustment elements 5, 6, 7; 8, 9, 10 can also be simultaneously adjusted upwards in a vertical direction, whereby the two handles 2; 3 of the steering wheel 1 are additionally moved in this direction. If necessary, this creates even more free space in front of the steering wheel 1 for the driver of the motor vehicle.

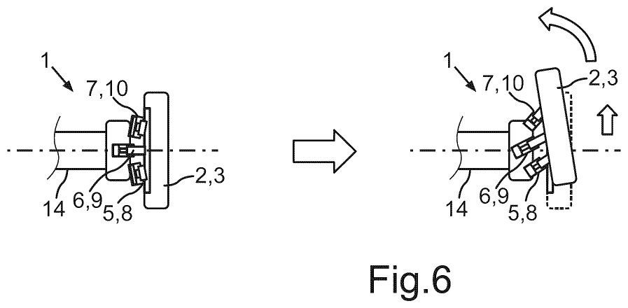

In FIG. 6, a further adjustment possibility of the two handles 2; 3 of the steering wheel 1 is depicted in a side view of the steering wheel 1, which is advantageous, for example, for comfortable handling of the steering wheel 1 and in particular for a driver of the motor vehicle with long arms.

For this purpose, the telescopic adjustment elements 5, 6, 7; 8, 9, 10 are moved upwards in a vertical direction from the starting position depicted on the left in FIG. 6, whereby the two handles 2; 3 of the steering wheel 1 are also moved in this direction to the end position depicted on the right in FIG. 6.

In addition to this vertical adjustment of the telescopic adjustment elements 5, 6, 7; 8, 9, 10 and thus of the two handles 2; 3 of the steering wheel 1, the two handles 2; 3 of the steering wheel 1 can also be tilted forwards in the direction of the steering column 14 of the steering wheel 1. In doing so, a greater distance from the driver's seat of the motor vehicle to the steering wheel 1 is created, which is often necessary or desirable for comfortable operation of the steering wheel.

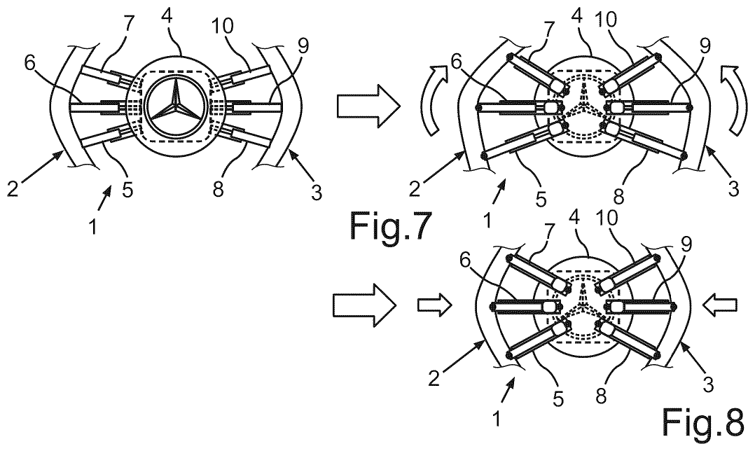

In FIG. 7, a further adjustment possibility of the two handles 2; 3 of the steering wheel 1 is depicted in a front view of the steering wheel 1.

To do so, the telescopic adjustment elements 5, 6, 7; 8, 9, 10 are adjusted from the starting position depicted on the left in FIG. 7 in such a way that the two handles 2; 3 of the steering wheel 1 assume a twisted position in relation to each other in the end position depicted on the right in FIG. 7. In particular, this is implemented by extending the respectively lowest telescopic adjustment elements 5, 8 further than the respectively middle telescopic adjustment elements 6, 9, while the respectively uppermost telescopic adjustment elements 7, 10 are not extended.

This adjustment of the two handles 2; 3 of the steering wheel 1 can be necessary or desirable, for example, in order to implement an advantageous ergonomic arrangement of the two handles 2, 3, on the one hand, and also to be able to achieve a higher steering torque in the lower area of the steering wheel 1 or the steering handle due to the greater distance between the two handles 2, 3 there on the other hand, without here restricting the view of the driver of surrounding operating elements, for example those arranged on the steering column or dashboard.

Finally, in FIG. 8 a further adjustment possibility for the two handles 2; 3 of the steering wheel 1 is depicted in a front view of the steering wheel 1.

To do so, the telescopic adjustment elements 5, 6, 7; 8, 9, 10 are adjusted from the starting position depicted on the left in FIG. 8 in such a way that the two handles 2; 3 of the steering wheel 1 assume a smaller distance from each other in the end position depicted on the right in FIG. 8.

This may be desirable, for example, to implement a “sporty” character of the steering of the motor vehicle and thus a sporty or sportive appearance of the steering wheel 1 of the motor vehicle.

1.-10. (canceled)

11. A steering wheel (1), comprising:
a steering handle, wherein the steering handle is formed by a first handle (2) disposed on a first side (15) of the steering wheel (1) and a second handle (3) disposed on a second side (16) of the steering wheel (1); and
an impact absorber (4) disposed in a center of the steering wheel (1) between the first side (15) and the second side (16);
wherein the first handle (2) is connected to the impact absorber (4) via at least a first three telescopic adjustment elements (5, 6, 7) and wherein the second handle (3) is connected to the impact absorber (4) via at least a second three telescopic adjustment elements (8, 9, 10).

12. The steering wheel (1) according to claim 11, wherein the at least first three telescopic adjustment elements (5, 6, 7) are disposed on the first side (15) of the steering wheel (1) in two planes lying offset in relation to each other and wherein the at least second three telescopic adjustment elements (5, 6, 7) are disposed on the second side (16) of the steering wheel (1) in two planes lying offset in relation to each other.

13. The steering wheel (1) according to claim 11, wherein each of the telescopic adjustment elements (5, 6, 7; 8, 9, 10) is connected to the respective handle (2; 3) via a respective first 3D-bearing (12) and to the impact absorber (4) via a respective second 3D-bearing (12).

14. The steering wheel (1) according to claim 11, wherein each of the telescopic adjustment elements (5, 6, 7; 8, 9, 10) has a respective drive device (11) and wherein each of the telescopic adjustment elements (5, 6, 7; 8, 9, 10) has a respective length that is adjustable by the respective drive device (11).

15. The steering wheel (1) according to claim 14, wherein the drive device (11) is an electromotive drive device or a pneumatic drive device or a hydraulic drive device.

16. The steering wheel (1) according to 14, wherein the drive device (11) has a worm drive.

17. The steering wheel (1) according to claim 11, wherein each of the telescopic adjustment elements (5, 6, 7; 8, 9, 10) has a respective cover.

18. The steering wheel (1) according to claim 17, wherein the cover is formed as a flexible bellows or as an interlocking cover element or as a cover element that is inherently shiftable.

19. The steering wheel (1) according to claim 11, wherein via the telescopic adjustment elements (5, 6, 7; 8, 9, 10), the first handle (2) and the second handle (3) are axially shiftable in a direction of a steering axis of a steering column (14) of the steering wheel (1) and/or are radially shiftable and/or are height adjustable and/or are angularly adjustable.

20. The steering wheel (1) according to claim 11, wherein the first handle (2) and the second handle (3) are shiftable during a steering actuation of the steering wheel (1) via the telescopic adjustment elements (5, 6, 7; 8, 9, 10).
